(19) United States
(12) Patent Application Publication
(10) Pub. No.: US 2026/0086540 A1
(43) Pub. Date: Mar. 26, 2026

(54) MINING SUPPLIER IDENTIFIER MATCHING AND INTERFACE

(71) Applicant: CADEN MCBRIDE, South Jordan, UT (US)

(72) Inventor: CADEN MCBRIDE, South Jordan, UT (US)

(21) Appl. No.: 19/196,661

(22) Filed: May 1, 2025

Related U.S. Application Data
(60) Provisional application No. 63/640,933, filed on May 1, 2024.

(51) Int. Cl. G05B 19/418; G06N 7/02; G06Q 30/08

(52) U.S. Cl. CPC G05B 19/41845; G05B 19/4183; G06N 7/02; G06Q 30/08

(57) ABSTRACT

Apparatuses, systems, methods, and computer program products are disclosed for mining supplier identifier matching and interfaces. A method includes maintaining a database storing supplier mining equipment identifiers and manufacturer mining equipment identifiers. A method includes correlating supplier mining equipment identifiers with manufacturer mining equipment identifiers using a matching algorithm that applies fuzzy logic and data clustering to resolve non-standardized identifier discrepancies, thereby creating mappings between the supplier mining equipment identifiers and the manufacturer mining equipment identifiers in a database. A method includes providing, via an application programming interface (API), dynamic, real-time access for users to query and retrieve mining equipment manufacturer information based on the correlated supplier mining equipment identifiers.

### CROSS-REFERENCES TO RELATED APPLICATIONS

This application claims the benefit of U.S. Provisional Patent Application No. 63/640,933 entitled “MINING SUPPLIER IDENTIFIER MATCHING AND INTERFACE” and filed on May 1, 2024, for Caden McBride, which is incorporated herein by reference in its entirety for all purposes.

### FIELD

This invention relates to mining and more particularly relates to aggregating and matching mining supplier identifiers and providing a mining procurement interface.

### BACKGROUND

The mining equipment industry typically relies on efficient procurement processes, yet suppliers often face challenges in matching supplier identifiers for mining equipment to manufacturer identifiers for the mining equipment, leading to inefficiencies and reduced competitiveness. Existing systems lack standardized methods for identifier correlation and supplier-manufacturer interaction, especially across multiple suppliers.

### BRIEF SUMMARY

Apparatuses, systems, methods, and computer program products are disclosed for mining supplier identifier matching and interfaces. In one embodiment, an apparatus includes a processor and a memory that stores code executable by the processor to perform operations. An operation, in one embodiment, includes maintaining a database storing supplier mining equipment identifiers and manufacturer mining equipment identifiers. In a further embodiment, an operation includes correlating supplier mining equipment identifiers with manufacturer mining equipment identifiers using a matching algorithm that applies fuzzy logic and data clustering to resolve non-standardized identifier discrepancies to create mappings between the supplier mining equipment identifiers and the manufacturer mining equipment identifiers in a database. An operation, in certain embodiments, includes providing, via an application programming interface (API), dynamic, real-time access for users to query and retrieve mining equipment manufacturer information based on correlated supplier mining equipment identifiers.

In some embodiments, a computer program product comprises executable code stored on a non-transitory computer readable storage medium, executable by a processor to perform operations. In one embodiment, an operation includes maintaining a database storing supplier mining equipment identifiers and manufacturer mining equipment identifiers. An operation, in certain embodiments, includes correlating supplier mining equipment identifiers with manufacturer mining equipment identifiers using a matching algorithm that applies fuzzy logic and data clustering to resolve non-standardized identifier discrepancies to create mappings between the supplier mining equipment identifiers and the manufacturer mining equipment identifiers in a database. In a further embodiment, an operation includes providing, via an application programming interface (API), dynamic, real-time access for users to query and retrieve mining equipment manufacturer information based on correlated supplier mining equipment identifiers.

In a further embodiment, an apparatus includes means for maintaining a database storing supplier mining equipment identifiers and manufacturer mining equipment identifiers. An apparatus, in some embodiments, includes means for correlating supplier mining equipment identifiers with manufacturer mining equipment identifiers using a matching algorithm that applies fuzzy logic and data clustering to resolve non-standardized identifier discrepancies to create mappings between the supplier mining equipment identifiers and the manufacturer mining equipment identifiers in a database. An apparatus, in certain embodiments, includes means for providing, via an application programming interface (API), dynamic, real-time access for users to query and retrieve mining equipment manufacturer information based on correlated supplier mining equipment identifiers.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for mining supplier identifier matching and interface; and

FIG. 2 is a schematic block diagram illustrating one embodiment of a method for mining supplier identifier matching and interface.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

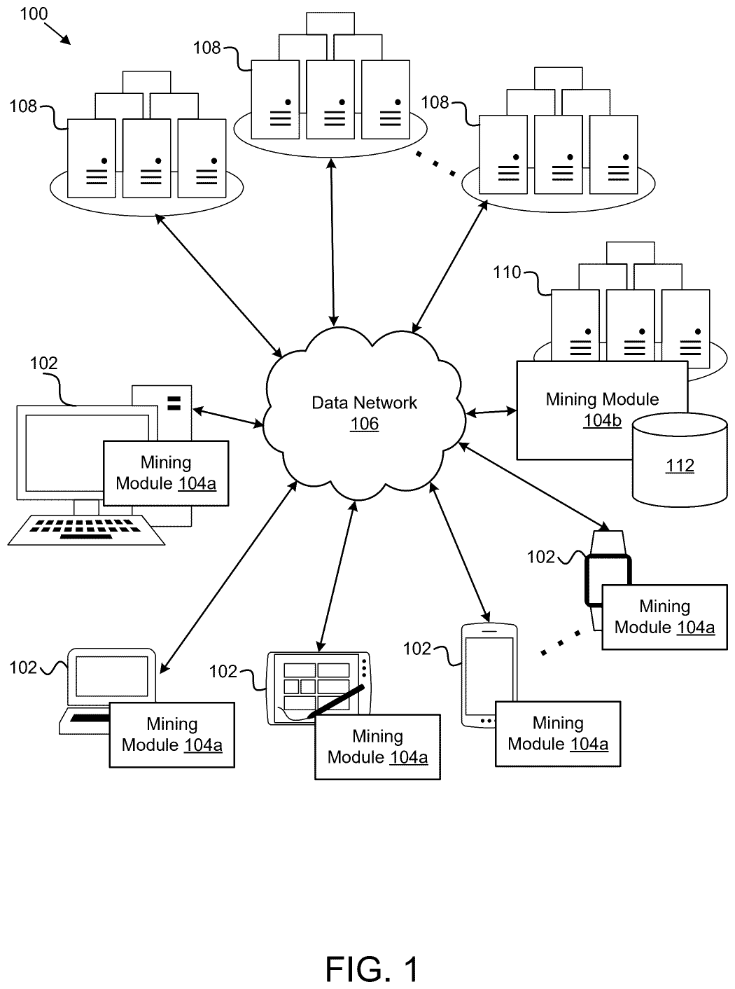

FIG. 1 depicts one embodiment of a system 100 for mining supplier identifier matching and/or interface. In one embodiment, the system 100 includes one or more hardware devices 102, one or more mining modules 104 (e.g., a backend mining module 104b and/or a plurality of mining modules 104a disposed on the one or more hardware devices 102), one or more data networks 106 or other communication channels, one or more third-party providers 108 (e.g., one or more servers 108 of one or more providers 108; one or more cloud or network providers, or the like), and/or one or more backend servers 110. In certain embodiments, even though a specific number of hardware devices 102, mining modules 104, data networks 106, third-party providers 108, and/or backend servers 110 are depicted in FIG. 1, one of skill in the art will recognize, in light of this disclosure, that any number of hardware devices 102, mining modules 104, data networks 106, third-party providers 108, and/or backend servers 110 may be included in the system 100 for mining supplier identifier matching and/or interface.

In one embodiment, a mining module 104 is configured to match one or more mining and/or other mechanical equipment supplier identifiers (IDs) to manufacturers (e.g., in the mining equipment industry or the like). A mining module 104 may comprise and/or have access to one or more of a database 112 and/or other data store storing supplier mining equipment identifiers and/or corresponding manufacturer mining equipment identifiers, an algorithm for matching identifiers (e.g., for matching supplier mining equipment identifiers to corresponding manufacturer mining equipment identifiers, or the like) or other mapping, and/or an API or other interface for users (e.g., suppliers or the like) to access this information. In this manner, in various embodiments, a mining module 104 may improve accuracy in matching identifiers, enhance competition (e.g., among equipment suppliers), increase transparency (e.g., in procurement), streamline equipment procurement/sourcing, and/or enhance supplier interactions in real time.

In some embodiments, a matching algorithm of a mining module 104 may use machine learning, fuzzy logic, data clustering and/or predictive analytics to correlate supplier mining equipment identifiers and manufacturer mining equipment identifiers, create mappings between supplier mining equipment identifiers and manufacturer mining equipment identifiers, or the like. For example, a mining module 104 may use historical data analysis and machine learning to optimize a procurement process in the mining equipment industry, or the like. An API and/or other interface of a mining module 104, in certain embodiments, may provide secure endpoints for suppliers or other users to query and/or otherwise interact with manufacturer information based on supplier mining equipment identifiers, or the like.

In some embodiments, a mining module 104 may comprise an at least partially software component (e.g., executable code stored on a non-transitory computer readable storage medium, or the like) that operates on one or more hardware devices 102 and/or backend servers 110, which may include computers, servers, tablets, or other computing devices connected via one or more data networks 106. In certain embodiments, data networks 106 may include local area networks (LANs), wide area networks (WANs), the Internet, satellite networks, or any combination thereof, facilitating communication between a mining module 104, hardware devices 102, backend servers 110, and/or third-party providers 108, or the like.

In some embodiments, a mining module 104 may be executed on one or more backend servers 110, which may be specialized servers designed to handle the computational load and data storage requirements of the system 100. In certain embodiments, the backend servers 110 may be located in a data center, a cloud environment, or distributed across multiple geographic locations to ensure scalability, reliability, and/or low-latency access over the data networks 106.

One or more mining modules 104 may interact with one or more third-party providers 108, which in some embodiments may include mining equipment suppliers, mining equipment manufacturers, or the like. In some embodiments, these third-party providers 108 may provide data, such as supplier mining equipment identifiers, manufacturer mining equipment identifiers, equipment technical specifications, equipment pricing, customized equipment pricing quotes, equipment availability, equipment shipping/timing information, equipment customizations, equipment maintenance information, or the like which may be transmitted over one or more data networks 106 and used by a mining module 104 to perform matching and/or correlation operations.

In various embodiments, a supplier mining equipment identifier may comprise a unique identifier assigned to and/or by a supplier of mining equipment (e.g., identifying the supplier itself; identifying mining equipment sold, rented, or otherwise provided by the supplier; or the like), which may take various forms depending on the context and/or system in use. For example, in some embodiments, a supplier mining equipment identifier may be an internal or external ID assigned by a mining equipment supplier to a specific make, model, and/or other type of mining equipment (e.g., a unique identifier, an equipment name or other string, a stock keeping unit (SKU), a barcode, a quick response (QR) code, a catalogue number, a uniform resource locator (URL) or other link, or the like).

In some embodiments, a supplier mining equipment identifier may identify a supplier itself, such as a standardized code (e.g., a DUNS number, a tax identification number, a GS1 Global Location Number (GLN), an International Standard Name Identifier (ISNI), or the like). In other embodiments, a supplier mining equipment identifier may comprise a custom alphanumeric string generated by the mining module 104 based on supplier and/or equipment characteristics like name, location, equipment type, or the like. Additionally, in certain embodiments, a supplier mining equipment identifier may include a combination of multiple elements, such as a supplier's name and a unique serial number, may include a proprietary code used within a specific procurement platform, or the like. In further embodiments, a supplier mining equipment identifier may be derived from one or more industry-specific databases, such as a supplier registry maintained by a mining association, may be linked to certifications such as ISO standards for mining equipment, or the like.

In one embodiment, a manufacturer mining equipment identifier may comprise a unique identifier associated with a manufacturer of mining equipment (e.g., assigned to a manufacturer, assigned by a manufacturer, identifying a manufacturer, identifying equipment made and/or supplied by a manufacturer, or the like), enabling differentiation between mining manufacturers and/or mining equipment. For example, in some embodiments, a mining equipment identifier may comprise a manufacturer's name, a trademark or other name for a manufacturer and/or product, an abbreviated version of cither, or the like. In other embodiments, a mining equipment identifier may include an industry-standard code, such as a DUNS number, a tax identification number, a GS1 Global Location Number (GLN), an International Standard Name Identifier (ISNI), or the like. Additionally, in certain embodiments, a manufacturer mining equipment identifier may comprise a custom code generated by a mining module 104, supplied by one or more third-party providers 108, reflecting one or more attributes of a manufacturer and/or of a manufacturer's mining equipment. For example, a manufacturer mining equipment identifier may include equipment-specific details, such as serial numbers and/or model numbers. In further embodiments, a manufacturer mining equipment identifier may comprise one or more advanced digital solutions, such as blockchain-based tokens, smart contract addresses, or the like (e.g., to enhance traceability within the mining industry).

In some embodiments, mining equipment manufacturers and suppliers may use different names, serial numbers, or other identifiers to refer to the same mining equipment. For example, some mining equipment may be white labeled and/or rebranded, some mining equipment suppliers may use internal and/or custom identifiers for mining equipment, some mining equipment manufacturers may use internal and/or custom identifiers for mining equipment, or the like. Without consistent identifiers or identifier standards, it may be difficult or impossible for users to compare mining equipment and/or mining equipment pricing, to locate similar mining equipment and/or compatible equipment parts, to locate or request proper equipment service, to determine mining equipment specifications, or the like, without correlations and/or mappings from a mining module 104.

In certain embodiments, a mining module 104 may maintain a database 112 and/or other data structure that stores supplier mining equipment identifiers, manufacturer mining equipment identifiers, and/or mappings therebetween. The database 112 may be a relational database 112, a NoSQL database 112, a graph database 112, or another data storage system. In one embodiment, the database 112 may include a table structure specifically configured to store bidirectional mappings between the supplier mining equipment identifiers and the manufacturer mining equipment identifiers, which may allow for efficient querying and/or retrieval of correlated data by a mining module 104.

For example, in some embodiments, the database 112 may have a ‘suppliers’ table with columns for one or more of supplier mining equipment identifier, supplier name, equipment type, or the like. Similarly, there may be a ‘manufacturers’ table with columns for one or more of manufacturer mining equipment identifier, manufacturer name, equipment type, equipment specifications, equipment pricing, equipment availability, equipment shipping/timing information, equipment customization, equipment maintenance information, or the like. Additionally, a ‘mappings’ table may store correlations or other mappings between supplier mining equipment identifiers and manufacturer mining equipment identifiers, additional metadata such as a confidence level of the match, a date and/or time of correlation (e.g., a timestamp), the source of the data (e.g., third-party providers 108), or the like.

In some embodiments, the database 112 may be configured to store metadata associated with supplier mining equipment identifiers, such as a geographical location of the supplier (e.g., address, zip code, latitude and longitude coordinates, or the like), their specialization in certain types of mining equipment (e.g., underground vs. surface mining, or the like), their annual supply volume, and/or other metadata. This metadata may be used by a mining module 104 to enhance the accuracy of the matching algorithm, to provide additional context to users via the API, or the like.

In certain embodiments, the database 112 may be distributed across multiple backend servers 110 to ensure fault tolerance and/or high availability. In one embodiment, a mining module 104 may implement data replication strategies to synchronize the database 112 across these servers, ensuring that updates from third-party providers 108 are reflected consistently over the data network 106.

In some embodiments, a mining module 104 may update the database 112 in real-time with new supplier mining equipment identifiers, manufacturer mining equipment identifiers, and/or metadata as they become available. For example, a mining module 104 may poll one or more third-party providers 108 over a data network 106, may receive push notifications via the API, or the like to ensure that the mining module 104 has current data, for accurate matching and/or procurement decisions.

In certain embodiments, the database 112 may be configured to store historical data on supplier and manufacturer interactions, such as procurement success rates, delivery times, equipment pricing, custom equipment price quotes, equipment quality metrics, or the like. This historical data may be used by a mining module 104 to improve the matching algorithm's accuracy over time and/or to generate procurement reports for users.

A mining module 104 may use a matching algorithm to correlate supplier mining equipment identifiers with manufacturer mining equipment identifiers. In one embodiment, the matching algorithm may apply fuzzy logic and/or data clustering techniques to resolve non-standardized identifier discrepancies, which may be prevalent in the mining equipment industry due to legacy systems, regional variations, typographical errors, different identifier conventions between suppliers and manufacturers, or the like.

In some embodiments, fuzzy logic may allow the algorithm to handle partial matches and/or typographical variations in the supplier mining equipment identifiers. For example, if a supplier mining equipment identifier is ‘ABC-123’ and a manufacturer mining equipment identifier is ‘ABC123,’ the fuzzy logic component executed by a mining module 104 may recognize that these are likely referring to the same mining equipment despite the slight difference in formatting. In certain embodiments, the fuzzy logic may assign a similarity score (e.g., 0 to 1) based on string comparison techniques such as Levenshtein distance, cosine similarity, or Jaro-Winkler distance, which may be adjustable based on industry-specific requirements, or the like.

In addition to fuzzy logic, the matching algorithm may employ data clustering to group similar supplier mining equipment identifiers based on predefined industry-specific attributes, or the like. In one embodiment, these attributes may include the type of equipment supplied (e.g., excavators, conveyors), geographical location (e.g., proximity to mining sites), historical procurement data (e.g., frequency of transactions with specific manufacturers), or the like. By clustering similar supplier mining equipment identifiers, a mining module 104 may more accurately match supplier mining equipment identifiers to the corresponding manufacturer mining equipment identifiers, reducing false positives and improving mapping reliability, or the like.

In some embodiments, the matching algorithm may further utilize one or more machine learning models to improve correlation accuracy over time. These models, executed by a mining module 104 on hardware devices 102 and/or backend servers 110, may be trained on historical data analysis of supplier and manufacturer interactions, which may be sourced from third-party providers 108, internal system logs, or the like. In certain embodiments, the models may include supervised learning approaches (e.g., logistic regression, random forests, or the like) or unsupervised learning approaches (e.g., k-means clustering, neural networks, or the like) to learn patterns and/or relationships that may enhance the matching process. As the mining module 104 collects more data over a data network 106 and retrains the models, an accuracy of the correlations and/or mappings may improve incrementally over time.

Moreover, in one embodiment, the matching algorithm may prioritize correlations based on historical procurement success rates between suppliers and manufacturers. For example, if a particular supplier has a high success rate (e.g., 95% on-time delivery, or the like) in procuring equipment from a specific manufacturer, a mining module 104 may assign a higher confidence score to that mapping, which the mining module 104 may store in the database 112 and reflect in API responses.

In certain embodiments, the matching algorithm may be configured to adapt to changes in identifier formats over time. This adaptability may be useful as industry standards evolve, such as the adoption of new naming conventions or international identifier codes (e.g., ISO standards or the like). In some embodiments, a mining module 104 may periodically analyze incoming data from third-party providers 108 to detect format shifts and update the algorithm's parameters accordingly, ensuring long-term effectiveness, or the like.

In one embodiment, the matching algorithm may also incorporate rule-based heuristics as a fallback mechanism. For example, if fuzzy logic and clustering yield ambiguous results, a mining module 104 may apply one or more predefined rules (e.g., exact matches on equipment type codes or the like) to resolve conflicts, which may be useful for initial system deployments with limited historical data, or the like.

In some embodiments, the matching algorithm may use natural language processing (NLP) to extract and/or correlate unstructured mining equipment supplier and/or manufacturer data from industry-specific documents, such as contracts, invoices, equipment specifications, or the like. The NLP component, executed by a mining module 104, may analyze text to identify relevant identifiers and/or relationships (e.g., supplier mining equipment identifiers, manufacturer mining equipment identifiers, or the like in contract clauses and/or other documents), which a mining module 104 may use to create and/or refine mappings in the database 112. In certain embodiments, the NLP may employ techniques such as named entity recognition (NER), sentiment analysis, and/or topic modeling, with results validated against structured data from the database 112, or the like.

In one embodiment, the mining module 104 provides dynamic, real-time access for users to query and retrieve mining equipment manufacturer information based on the correlated supplier mining equipment identifiers via an application programming interface (API). In some embodiments, the API may be a RESTful API that allows users to send HTTP requests over the data networks 106 to retrieve data from the database 112 using HTTP requests over a data network 106. In some embodiments, the API may provide endpoints for retrieving manufacturer information based on supplier mining equipment identifiers, as well as for submitting new identifiers and/or updating existing ones by authorized users and/or third-party providers 108.

For example, in certain embodiments, a user may send a GET request to ‘/manufacturers?supplier_id=ABC-123’ to retrieve manufacturer information correlated with the supplier mining equipment identifier ‘ABC-123.’ A mining module 104 may process this request on a backend server 110 and respond with the relevant data in a structured format, such as JSON, XML, or the like which may include fields like manufacturer name, equipment types, confidence score, or the like.

In some embodiments, the API may support batch queries, enabling users to retrieve manufacturer information for multiple supplier mining equipment identifiers substantially simultaneously. For instance, a POST request to ‘/manufacturers/batch’ with a payload containing a list of supplier mining equipment identifiers (e.g., [′ABC-123′, ‘XYZ-456’], or the like) may return a consolidated response, which may be particularly useful for large-scale procurement operations, for greater efficiency, or the like.

In certain embodiments, the API may include authentication mechanisms to ensure that only authorized users can access the data. The mining module 104 may implement API keys, OAuth tokens, JSON Web Tokens (JWT), or other security measures for secure access over a data network 106. In one embodiment, the API may also support role-based access control (RBAC), allowing different levels of access (e.g., read-only, read-write, or the like) depending on the user's credentials, which may be verified over the data network 106.

In some embodiments, the API may be configured to integrate with one or more existing mining equipment procurement systems operated by third-party providers 108. This integration may allow for substantially seamless supplier-manufacturer interactions, as data may be exchanged between systems without manual intervention. For example, a mining module 104 may expose a webhook endpoint that procurement systems can subscribe to for receiving real-time updates on new mappings, or the like.

Furthermore, in certain embodiments, the API may provide a dynamic pricing interface, enabling users to access real-time manufacturer pricing data correlated with supplier mining equipment identifiers, or the like. For example, the API may provide an endpoint such as ‘/pricing?supplier_id=ABC,’ where a mining module 104 retrieves pricing information from the database 112 or directly from third-party providers 108 via a data network 106, facilitating competitive bidding, helping suppliers make informed decisions, or the like.

In one embodiment, the API may support versioning (e.g., ‘/v1/manufacturers’) to allow for future enhancements without disrupting existing users. In some embodiments, a mining module 104 may implement rate limiting to prevent abuse, ensuring fair access to the backend servers 110 across users and third-party providers 108, or the like.

In certain embodiments, the API may be configured to support blockchain-based verification of the supplier mining equipment identifiers and/or manufacturer mining equipment identifiers. By leveraging blockchain technology, a mining module 104 may ensure immutable, tamper-proof mappings, enhancing trust and/or security in procurement transactions. For example, each mapping may be recorded as a transaction on a distributed ledger, with a hash accessible via the API for verification by third-party providers 108 or users. In certain embodiments, a mining module 104 may support the use of smart contracts on blockchain networks to automate procurement processes, such as automatically executing payments and/or updating inventory levels in response to certain conditions being met, based on the correlated supplier and manufacturer data or the like.

In one embodiment, a mining module 104 may generate one or more procurement reports based on correlated supplier mining equipment identifiers and manufacturer mining equipment identifiers. For example, these reports may provide insights into procurement trends (e.g., seasonal demand), supplier performance (e.g., delivery reliability), manufacturer reliability (e.g., defect rates), or the like, which may be accessed via the API, exported as PDF or CSV files by authorized users, or the like.

In some embodiments, a mining module 104 may validate supplier mining equipment identifiers against a predefined set of industry standards and/or other validation data prior to correlation. This validation step, performed by a mining module 104, may include checking identifier formats against standards such as GS1, ISO 8000, and/or custom mining industry conventions (e.g., maintaining data integrity and/or ensuring that only valid identifiers are processed by the matching algorithm, or the like).

In certain embodiments, a mining module 104 may provide one or more notifications to one or more users in response to one or more new mappings being created in the database 112. A mining module 104 may deliver a notification via email, SMS, push notifications, or the like over a data network 106, keeping users informed of updates and/or allowing them to act on new information promptly. In some embodiments, users may configure notification preferences through the API and/or another user interface of a mining module 104, specifying conditions such as confidence thresholds, specific supplier IDs of interest, or the like.

In one embodiment, a mining module 104 may include functionality for forecasting supplier-manufacturer compatibility using predictive analytics based on real-time market trends and/or historical procurement data. In this manner, in certain embodiments, a mining module 104 may optimize supplier selection for cost efficiency and/or reliability by predicting which suppliers are most likely to successfully procure equipment from specific manufacturers, or the like. In some embodiments, a mining module 104 may use predictive analytics leveraging regression models, time-series analysis, deep learning, or the like, with results accessible via the API and/or another user interface of a mining module 104.

In some embodiments, a mining module 104 may support the integration of one or more external data sources, such as weather data, commodity prices, geopolitical risk assessments, or the like to enhance predictive capabilities. For example, a mining module 104 may adjust supplier-manufacturer compatibility forecasts based on predicted weather patterns that could affect mining operations and/or equipment delivery times, or the like.

In certain embodiments, a mining module 104 may provide a user-friendly graphical interface for users to interact with the API, visualize mappings, override mappings, generate reports, or the like. This interface may be accessible via web browsers and/or executable desktop/mobile applications running on hardware devices 102, communicating with a mining module 104 over the data networks 106, or the like.

In one embodiment, a mining module 104 may implement one or more data anonymization and/or encryption techniques to protect sensitive information, such as supplier pricing, proprietary manufacturer data, or the like, ensuring compliance with industry regulations, data privacy standards, or the like.

In some embodiments, a mining module 104 may provide a feedback mechanism allowing users to report inaccuracies in the mappings and/or to suggest corrections, which the mining module 104 may use to refine the matching algorithm, update the database 112, or the like. This feedback loop may be facilitated through the API and/or another user interface of a mining module 104.

In certain embodiments, a mining module 104 may be designed to scale horizontally, allowing additional backend servers 110 to be added as the volume of data or the number of users increases. This scalability may ensure that a mining module 104 can handle growing demands without compromising performance or reliability. In one embodiment, a mining module 104 may support multi-tenancy, allowing multiple mining companies and/or organizations to use a mining module 104 independently, with their data isolated and secured (e.g., for large enterprises and/or industry consortia looking to standardize procurement processes across multiple divisions, partners, or the like).

In some embodiments, a mining module 104 may maintain an audit trail that logs all changes to the database 112, API queries, user interactions, or the like (e.g., providing a comprehensive record for compliance, troubleshooting, and/or performance analysis purposes). In certain embodiments, a mining module 104 may be configured to handle multiple languages or regional identifier formats, thereby supporting global operations in the mining equipment industry. A mining module 104 may incorporate language-specific fuzzy logic rules and/or clustering attributes tailored to different regions.

In one embodiment, a mining module 104 may provide an offline mode or caching mechanism, allowing users to access recently queried data even when connectivity to the data networks 106 is limited (e.g., in remote mining locations, or the like). In some embodiments, a mining module 104 may integrate with Internet of Things (IoT) devices and/or sensors used in mining equipment to automatically update supplier and/or manufacturer data based on real-time equipment usage, performance metrics, or the like. For example, a mining module 104 may use equipment maintenance records and/or usage statistics to refine supplier-manufacturer mappings, to predict future procurement needs, or the like.

In one embodiment, a mining module 104 may support the creation of custom matching rules and/or attributes (e.g., by advanced users, administrators, or the like) allowing organizations to tailor the algorithm to their specific procurement strategies and/or industry niches. In some embodiments, a mining module 104 may provide integration with enterprise resource planning (ERP) systems, customer relationship management (CRM) systems, or other business software used by mining companies, enabling seamless data flow and/or reducing manual data entry. In one embodiment, a mining module 104 may offer a subscription-based access model, where different tiers of service provide varying levels of API access, data storage, or advanced features, catering to the needs of small suppliers, large manufacturers, industry consultants, or the like.

In some embodiments, a mining module 104 may be designed to comply with industry-specific standards or regulations, such as those related to data security, procurement transparency, or environmental sustainability reporting, ensuring that a mining module 104 meets one or more legal and/or ethical requirements of the mining equipment industry, or the like.

In some embodiments, a mining module 104 may provide real-time alerts and/or dashboards that highlight one or more procurement events, such as changes in supplier reliability, manufacturer pricing, or the like, enabling users to respond to market shifts. In one embodiment, a mining module 104 may include a marketplace feature where mining companies, suppliers, and/or manufacturers may directly negotiate, transact, or the like based on the correlated data, with a mining module 104 facilitating secure communication and transaction logging over a data network 106. In certain embodiments, a mining module 104 may provide a collaborative platform where multiple stakeholders, such as suppliers, manufacturers, mining companies, or the like may share insights, negotiate terms, and/or resolve disputes, with a mining module 104 facilitating secure communication and/or data exchange.

In one embodiment, a mining module 104 may provide a data quality dashboard that provides real-time metrics on accuracy, completeness, timeliness, or the like of the supplier and/or manufacturer data (e.g., helping administrators monitor and/or maintain an integrity of the database 112, or the like). In some embodiments, a mining module 104 may support the use of digital twins, creating virtual representations of mining equipment and/or supply chains that the mining module 104 uses to simulate and/or optimize procurement strategies based on real-time data, predictive analytics, or the like. In some embodiments, a mining module 104 may track and/or report on an environmental impact of procurement decisions, such as carbon emissions associated with equipment manufacturing and/or transportation (e.g., helping organizations meet their sustainability goals, or the like).

In certain embodiments, a mining module 104 may include a recommendation engine that suggests an optimal supplier and/or manufacturer for a user (e.g., a mining company user) based on user-defined criteria, such as cost, delivery time, equipment quality, or the like, leveraging the correlated data and/or predictive analytics. In one embodiment, a mining module 104 may provide a real-time collaboration feature, such as shared workspaces and/or chat functions, where procurement teams can work together on supplier selection, contract negotiation, or issue resolution.

In certain embodiments, a mining module 104 may include a supplier onboarding wizard that guides new suppliers through the process of registering their mining equipment identifiers and/or verifying their information (e.g., ensuring data accuracy from the start, or the like). In certain embodiments, a mining module 104 may support the use of federated learning, where machine learning models are trained collaboratively across multiple organizations (e.g., multiple mining companies, multiple mining equipment suppliers, multiple mining equipment manufacturers, or the like) without sharing raw data, enhancing privacy and/or collective intelligence, or the like.

In some embodiments, a mining module 104 may integrate with autonomous vehicle systems and/or other mining equipment used in mining operations (e.g., as hardware installed thereon and/or computer readable code executed by a processor installed thereon, or the like), using procurement data to optimize equipment maintenance schedules, fleet management, or the like.

In certain embodiments, a mining module 104 may comprise a computer program product comprising computer program code stored on a non-transitory computer readable storage medium, such as one or more hard drives, solid-state drives (SSDs), cloud storage, or the like. When executed by a processor on one or more hardware devices 102 and/or backend servers 110, this code may performs the operations described above, including maintaining the database, correlating identifiers using the matching algorithm, and/or providing the API for real-time access, (e.g., managed by a mining module 104, or the like).

In one embodiment, a means for maintaining a database 112 storing supplier mining equipment identifiers and/or manufacturer mining equipment identifiers may comprise a processor, a memory, a data network 106, a hardware computing device 102, a backend server 110, a mining module 104, and/or other similar or equivalent means for maintaining a database 112.

In some embodiments, a means for correlating supplier mining equipment identifiers with manufacturer mining equipment identifiers using a matching algorithm may comprise a processor, a memory, a data network 106, a hardware computing device 102, a backend server 110, a mining module 104, and/or other similar or equivalent means for correlating.

In certain embodiments, a means for providing, via an API, dynamic, real-time access for users to query and retrieve mining equipment manufacturer information may comprise a processor, a memory, a data network 106, a hardware computing device 102, a backend server 110, a mining module 104, and/or other similar or equivalent means for providing access for users to query and retrieve via an API.

In one embodiment, the system 100 includes one or more hardware devices 102. The hardware devices 102 (e.g., computing devices, information handling devices, or the like) may include one or more of a desktop computer, a laptop computer, a mobile device, a tablet computer, a smart phone, a set-top box, a gaming console, a smart TV, a smart watch, a fitness band, an optical head-mounted display (e.g., a virtual reality headset, smart glasses, or the like), an HDMI or other electronic display dongle, a personal digital assistant, and/or another computing device comprising a processor (e.g., a central processing unit (CPU), a processor core, a field programmable gate array (FPGA) or other programmable logic, an application specific integrated circuit (ASIC), a controller, a microcontroller, and/or another semiconductor integrated circuit device), a volatile memory, and/or a non-volatile storage medium. In certain embodiments, the hardware devices 102 are in communication with one or more servers 108 of one or more third-party providers 108 and/or one or more backend servers 110 via a data network 106, described below. The hardware devices 102, in a further embodiment, may be capable of executing various programs, program code, applications, instructions, functions, or the like.

In one embodiment, a mining module 104 is configured to determine and/or receive a user's electronic credentials (e.g., username and password, fingerprint scan, retinal scan, digital certificate, personal identification number (PIN), challenge response, security token, hardware token, software token, DNA sequence, signature, facial recognition, voice pattern recognition, bio-electric signals, two-factor authentication credentials, or the like) for one or more third-party providers 108. A mining module 104, in certain embodiments, accesses a server 108 of a third-party provider 108 using a user's electronic credentials to download data (e.g., stored by hardware not owned, maintained, and/or controlled by the user). A mining module 104, in various embodiments, may provide the downloaded data to a user locally (e.g., displaying the data on an electronic display of a hardware device 102); may provide the downloaded data from the hardware device 102 of the user to and/or package the data for a remote server 110 (e.g., a backend mining module 104b) or other remote device (e.g., another hardware device 102 of the user, a hardware device 102 of a different user, or the like) which may be unaffiliated with the third-party provider 108; may provide one or more alerts, messages, advertisements, or other communications to the user (e.g., on a hardware device 102) based on the downloaded data; or the like.

In one embodiment, one or more mining modules 104a comprise a distributed system 100, with one or more mining modules 104a and/or the associated hardware devices 102 downloading and/or aggregating data substantially independently (e.g., downloading data concurrently or non-concurrently, without a global clock, with independent success and/or failure of components). Distributed mining modules 104a may pass messages to each other and/or to a backend mining module 104b, to coordinate their distributed aggregation of data for users. In one embodiment, one or more mining modules 104a are decentralized (e.g., hardware devices 102 associated with users perform one or more aggregation functions such as downloading data), rather than relying exclusively on a centralized server or other device to perform one or more aggregation functions.

In a distributed and/or decentralized system 100, a central entity, such as a backend mining module 104b and/or a backend server 110, in certain embodiments, may still provide, to one or more mining modules 104a, one or more messages comprising instructions for accessing a server 108 of a third-party provider 108 using a user's credentials, or the like. For example, a backend mining module 104b may provide one or more mining modules 104a of one or more hardware devices 102 with one or more sets of instructions for accessing a server 108 of a third-party service 108, such as a location for entering electronic credentials (e.g., a text box, a field, a label, a coordinate, or the like), an instruction for submitting electronic credentials (e.g., a button to press, a link to click, or the like), one or more locations of data (e.g., a row in a table or chart, a column in a table or chart, a uniform resource locator (URL) or other address, a coordinate, a label, or the like), and/or other instructions or information, using which one or more mining modules 104a may access and download data.

In a further embodiment, one or more mining modules 104a may pass messages to each other, such as instructions for accessing a server 108 of a third-party provider 108 using electronic credentials, or the like, in a peer-to-peer manner. In another embodiment, a central entity, such as a backend mining module 104b, may initially seed one or more sets of instructions for accessing a server 108 of a third-party provider 108 using electronic credentials to one or more mining modules 104a, and the one or more mining modules 104a may send the one or more sets of instructions to other mining modules 104a, or the like.

The one or more mining modules 104, in certain embodiments, may provide an interface (e.g., an application programming interface (API)) to provide downloaded and/or aggregated data from servers 108 of one or more third-party providers 108 to one or more other entities (e.g., a remote server 110 or other hardware device 102 unaffiliated with the third-party provider 108, a backend mining module 104b, or the like). The interface, in one embodiment, comprises a private interface between mining modules 104a of users' hardware devices 102 and one or more backend mining modules 104b. For example, this may enable a backend mining module 104b to provide a user with access to downloaded and/or aggregated data at multiple locations, on multiple hardware devices 102, through multiple channels, or the like, even if the user's hardware device 102 which downloaded the data is turned off, out of battery, not connected to the data network 106, or the like. In another embodiment, the interface comprises a public and/or open interface, which may be secured, allowing a user to share downloaded data from a mining module 104 to one or more other tools, services, and/or other entities to store, process, and/or otherwise use the data.

In various embodiments, a mining module 104 may be embodied as hardware, software, or some combination of hardware and software. In one embodiment, a mining module 104 may comprise executable program code stored on a non-transitory computer readable storage medium for execution on a processor of a hardware device 102, a backend server 110, or the like. For example, a mining module 104 may be embodied as executable program code executing on one or more of a hardware device 102, a backend server 110, a combination of one or more of the foregoing, or the like. In such an embodiment, the various modules that perform the operations of a mining module 104 may be located on a hardware device 102, a backend server 110, a combination of the two, and/or the like.

In various embodiments, a mining module 104 may be embodied as a hardware appliance that can be installed or deployed on a backend server 110, on a user's hardware device 102 (e.g., a dongle, a protective case for a phone 102 or tablet 102 that includes one or more semiconductor integrated circuit devices within the case in communication with the phone 102 or tablet 102 wirelessly and/or over a data port such as USB or a proprietary communications port, or another peripheral device), or elsewhere on the data network 106 and/or collocated with a user's hardware device 102. In certain embodiments, a mining module 104 may comprise a hardware device such as a secure hardware dongle or other hardware appliance device (e.g., a set-top box, a network appliance, or the like) that attaches to another hardware device 102, such as a laptop computer, a server, a tablet computer, a smart phone, or the like, either by a wired connection (e.g., a USB connection) or a wireless connection (e.g., Bluetooth®, Wi-Fi®, near-field communication (NFC), or the like); that attaches to an electronic display device (e.g., a television or monitor using an HDMI port, a DisplayPort port, a Mini DisplayPort port, VGA port, DVI port, or the like); that operates substantially independently on a data network 106; or the like. A hardware appliance of a mining module 104 may comprise a power interface, a wired and/or wireless network interface, a graphical interface (e.g., a graphics card and/or GPU with one or more display ports) that outputs to a display device, and/or a semiconductor integrated circuit device as described below, configured to perform the functions described herein with regard to a mining module 104.

A mining module 104, in such an embodiment, may comprise a semiconductor integrated circuit device (e.g., one or more chips, die, or other discrete logic hardware), or the like, such as a field-programmable gate array (FPGA) or other programmable logic, firmware for an FPGA or other programmable logic, microcode for execution on a microcontroller, an application-specific integrated circuit (ASIC), a processor, a processor core, or the like. In one embodiment, a mining module 104 may be mounted on a printed circuit board with one or more electrical lines or connections (e.g., to volatile memory, a non-volatile storage medium, a network interface, a peripheral device, a graphical/display interface. The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of a mining module 104.

The semiconductor integrated circuit device or other hardware appliance of a mining module 104, in certain embodiments, comprises and/or is communicatively coupled to one or more volatile memory media, which may include but is not limited to: random access memory (RAM), dynamic RAM (DRAM), cache, or the like. In one embodiment, the semiconductor integrated circuit device or other hardware appliance of a mining module 104 comprises and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (SONOS), resistive RAM (RRAM), programmable metallization cell (PMC), conductive-bridging RAM (CBRAM), magneto-resistive RAM (MRAM), dynamic RAM (DRAM), phase change RAM (PRAM or PCM), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (NFC) network, an ad hoc network, and/or the like. The data network 106 may include a wide area network (WAN), a storage area network (SAN), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The one or more third-party providers 108, in one embodiment, may include one or more network accessible computing systems such as one or more web servers hosting one or more web sites, an enterprise intranet system, an application server, an application programming interface (API) server, an authentication server, or the like. The one or more third-party providers 108 may include systems related to various institutions or organizations. For example, a third-party provider 108 may include a system providing electronic access to an equipment manufacturer, an equipment reseller, an equipment wholesaler, an equipment supplier, or the like (e.g., for mining equipment, or the like), and/or another entity that stores data associated with mining and/or mining equipment, or the like. A third-party provider 108 may include an authorization system, such as an API; a login element or page of a web site, application, or similar front-end, where a user can provide credentials, such as a username/password combination, to access data; or the like.

In one embodiment, the one or more backend servers 110 and/or one or more backend mining modules 104b provide central management of multiple mining modules 104a. For example, the one or more backend mining modules 104b and/or a backend server 110 may store downloaded data from one or more mining modules 104a centrally, may provide instructions for one or more mining modules 104a to access data from one or more third-party providers 108, or the like. A backend server 110 may include one or more servers located remotely from the hardware devices 102 and/or the one or more third-party providers 108. A backend server 110 may comprise hardware of a mining module 104, may store executable program code of a mining module 104 in one or more non-transitory computer readable storage media, and/or may otherwise perform one or more of the various operations of a mining module 104 described herein in order to aggregate data from one or more third-party providers 108.

In certain embodiments, either in a distributed and/or decentralized manner from the hardware devices 102, or from a central location such as a backend server 110, a mining module 104 may be configured to provide an interface (e.g., a GUI, a CLI, an API, one or more web pages, a web-enabled application, or the like) to a user through a hardware device 102, allowing the user to manage multiple aggregators of the data (e.g., a backend server 110, one or more servers 108 of third-party providers 108, and/or other entities), manage aggregation and/or data access permissions, or the like. A mining module 104 may provide an interface (e.g., a GUI) for a user to revoke and/or add an authorization for a third-party provider 108 or other entity to aggregate data (e.g., from a different one or more third-party provider 108, or the like).

Although a mining module 104 may allow multiple third-party providers 108 to share and/or otherwise use the same data, in some embodiments, the multiple third-party providers 108 may maintain their own, different metadata, IDs, or the like for the same equipment, for the same data, or the like and a mining module 104 may map the IDs and/or other metadata (e.g., mapping supplier IDs to manufacturer IDs, or the like).

In embodiments where a mining module 104 comprises hardware (e.g., a semiconductor integrated circuit device such as an FPGA, an ASIC, or the like), a mining module 104 may comprise dedicated security hardware for storing and/or processing electronic credentials, downloaded data, and/or other sensitive and/or private data, such as a secure cryptoprocessor (e.g., a dedicated computer on a chip or microprocessor embedded in a packaging with one or more physical security measures) which does not output decrypted data to an unsecure bus or storage, which stores cryptographic keys, a secure storage device; a trusted platform module (TPM) such as a TPM chip and/or TPM security device; a secure boot ROM or other type of ROM; an authentication chip; or the like. In another embodiment, a mining module 104 may store and/or process electronic credentials, downloaded data, and/or other sensitive data in a secure and/or encrypted way using software and/or hardware of a user's existing hardware device 102 (e.g., encrypting data in RAM, NAND, and/or other general-purpose storage) with or without dedicated security hardware. In certain embodiments, a mining module 104 may encrypt and/or secure data (e.g., electronic credentials, downloaded data) associated with a first user that is received by, processed by, and/or stored by a second (e.g., different) user's hardware device 102 (e.g., from the first user's hardware device 102 over the data network 106 or the like), preventing the second user from accessing the first user's data while still allowing the first user's data to be downloaded and/or aggregated from a different user's hardware device 102.

In one embodiment, as described above, electronic credentials may comprise one or more of a username and password, fingerprint scan, retinal scan, digital certificate, personal identification number (PIN), challenge response, security token, hardware token, software token, DNA sequence, signature, facial recognition, voice pattern recognition, bio-electric signals, two-factor authentication credentials, or other information whereby a mining module 104 may authenticate and/or validate an identity of and/or an authorization of a user.

A mining module 104, in certain embodiments, may use a webpage interface of a server 108 of a third-party provider 108 to access the server 108 using a user's electronic credentials and/or to download data. For example, in certain embodiments, a mining module 104 may download/load a webpage from a server 108 of a third-party provider 108, enter a username and password or other electronic credentials for a user into textboxes in a form on the webpage, submit the username and password or other electronic credentials using a submit button or other interface element of the webpage, and/or otherwise submit electronic credentials using a website to gain authorized access to data on the server 108.

In response to successfully authenticating with and accessing a server 108 of a third-party provider 108 with a user's electronic credentials, a mining module 104 may download data from the server 108, to a hardware device 102 associated with the user, to a backend server 110, to a hardware device 102 of another user downloading the data in proxy for the user, or the like. In one embodiment, a mining module 104 sends or otherwise submits electronic credentials and/or receives or otherwise downloads data using an API or other access protocol of a server 108 of a third-party provider 108. For example, a mining module 104 may send a request in a format specified by and/or compatible with a server 108 (e.g., an API server 108) of a third-party provider 108. The sent request may comprise electronic credentials for a user or a portion thereof (e.g., a username and/or a password), a subsequent request may comprise electronic credentials for a user or a portion thereof (e.g., in response to receiving an acknowledgment from the server 108 for the first request, or the like), and/or a mining module 104 may use a different access protocol of a server 108.

In response to a request for data from a mining module 104 (e.g., in response to a mining module 104 authenticating a user using an access protocol of a server 108), a server 108 of a third-party provider 108 may send and/or return data (e.g., in one or more messages, packets, payloads, as a URL or other pointer to a location from where a mining module 104 may retrieve the data, or the like). A mining module 104, in various embodiments, may receive data directly from a server 108 of a third-party provider 108 over a data network 106; may receive a pointer, URL or other link to a location of data from a server 108 of a third-party provider 108; may receive data from another entity on a data network 106 (e.g., in response to a request from the server 108 of the third-party provider 108 to the other entity or the like); or may otherwise receive data according to an access protocol of a third-party provider 108.

In one embodiment, a third-party provider 108 provides a mining module 104 with an API or other access protocol. In a further embodiment, a mining module 104 may act as a wrapper for and/or a plugin or extension of, an application of a third-party provider 108 (e.g., a mobile application), and the application may have access to an API or other access protocol of the third-party provider 108. In another embodiment, a mining module 104 may be configured to use an API or other access protocol in a same manner as an application of a third-party provider 108 (e.g., a mobile application). In certain embodiments, a mining module 104 may cooperate with an application of a third-party provider 108, a web browser through which a user accesses services of a third-party provider 108, or the like to access data (e.g., accessing data already downloaded by an application and/or user, accessing a database 112 or other data store of an application and/or web browser, scanning and/or screen scraping a web page of a third-party provider 108, or the like).

A mining module 104, in certain embodiments, may access different third-party providers 108 in different manners. For example, a first third-party provider 108 may grant a mining module 104 with access to an API or other access protocol, while a mining module 104 may use a web page interface (e.g., screen scraping) to access and download data from a second third-party provider 108, or the like. In one embodiment, a remote backend server 110 may be associated with a first party provider 110 (e.g., a vendor and/or provider of a mining module 104) and a mining module 104 may download data associated with a user from both the first party provider 110 and from one or more third-party providers 108, aggregating the data together so that the user may access the data in a single interface and/or application.

A mining module 104, in certain embodiments, may store downloaded and/or aggregated data independently from the one or more third-party providers 108. For example, a mining module 104 may store downloaded and/or aggregated data on a hardware device 102 of the user, on a backend server 110 accessible by the user, or the like. In this manner, in certain embodiments, a user may control and/or access the user's data, even if a third-party provider 108 closes down or is not available, may use the user's data in any manner desired by the user even if the use is not supported by a third-party provider 108, or the like. A mining module 104, in one embodiment, in addition to and/or instead of downloading data from one or more third-party providers 108, may upload data to and/or change one or more settings of one or more third-party providers 108, in response to user input or the like.

In one embodiment, a mining module 104 provides a user's data downloaded by a mining module 104, from a hardware device 102 of a user to another entity, such as a hardware device 102 of another user, a remote server 110 or other remote device 102 unaffiliated with (e.g., not owned by, operated by, controlled by, or the like) the third-party provider 108 from which the data was downloaded, or the like. For example, a mining module 104 may provide an API or other interface to provide downloaded and/or aggregated data to a hardware device 102 of a user, to a backend mining module 104b, to a backend server 110, to a different third-party provider 108, to a different/second hardware device 102 of the user, or the like.

In certain embodiments, a mining module 104 provides a graphical user interface (GUI) on a hardware device 102 of a user, and provides downloaded data to a user through the GUI (e.g., allowing the user to view the data directly, providing one or more notifications and/or recommendations to the user based on the data, providing one or more tables or charts to the user based on the data, providing a summary of or one or more statistics related to the data, or the like). A mining module 104, in various embodiments, may provide a GUI to a user from the same hardware device 102 to which the data was downloaded, on a different hardware device 102 than the hardware device 102, 110 to which the data was downloaded, or the like.

A mining module 104, in certain embodiments, may provide one or more access controls to a user, allowing the user to define which devices 102, users, third-party providers 110, or the like may access which data. For example, a mining module 104 may provide an interface for a user to allow and/or restrict certain mobile applications, certain APIs for third-party services, certain plugins or extensions, certain users, certain hardware devices 102, and/or one or more other entities to access data downloaded for the user from one or more third-party providers 108 (e.g., with access controls by third-party provider 108 or other data source, by data type, by entity requesting access, and/or at another granularity). In this manner, a mining module 104, in certain embodiments, may comprise a local repository of aggregated data, which one or more other devices 102 and/or services may access and use, with a user's permission.

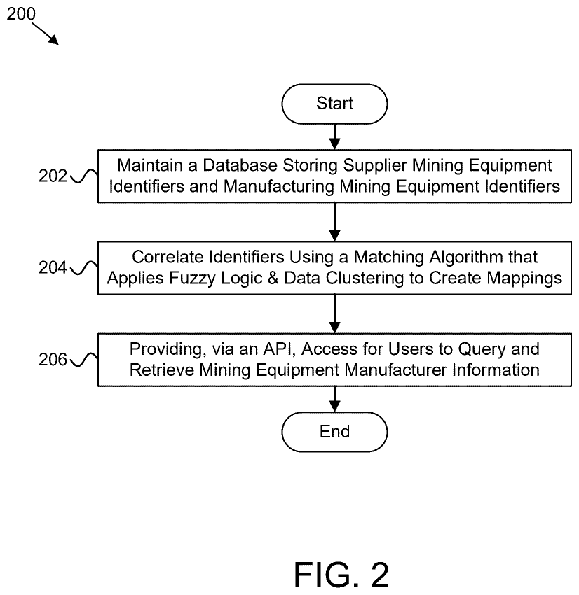

FIG. 2 depicts one embodiment of a method 200 for mining supplier identifier matching and an interface. The method 200 begins and a mining module 104 maintains 202 a database 112 storing supplier mining equipment identifiers and/or manufacturer mining equipment identifiers.

A mining module 104 correlates 204 supplier mining equipment identifiers with manufacturer mining equipment identifiers using a matching algorithm that applies fuzzy logic and data clustering to resolve non-standardized identifier discrepancies, thereby creating mappings between the supplier mining equipment identifiers and the manufacturer mining equipment identifiers in a database 112. A mining module 104 provides, via an application programming interface (API), dynamic, real-time access for users to query and retrieve mining equipment manufacturer information based on correlated supplier mining equipment identifiers and the method 200 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a processor;
a memory that stores code executable by the processor to perform operations, the operations comprising:
maintaining a database storing supplier mining equipment identifiers and manufacturer mining equipment identifiers;
correlating the supplier mining equipment identifiers with the manufacturer mining equipment identifiers using a matching algorithm that applies fuzzy logic and data clustering to resolve non-standardized identifier discrepancies, thereby creating mappings between the supplier mining equipment identifiers and the manufacturer mining equipment identifiers in the database; and
providing, via an application programming interface (API), dynamic, real-time access for users to query and retrieve mining equipment manufacturer information based on the correlated supplier mining equipment identifiers.

2. The apparatus of claim 1, wherein the matching algorithm further uses one or more machine learning models to improve correlation accuracy over time based on historical data analysis of supplier and manufacturer interactions.

3. The apparatus of claim 1, wherein the database includes a table structure configured to store bidirectional mappings between the supplier mining equipment identifiers and the manufacturer mining equipment identifiers.

4. The apparatus of claim 1, wherein the operations further comprise updating the database in real-time with new supplier mining equipment identifiers and manufacturer mining equipment identifiers as they become available.

5. The apparatus of claim 1, wherein the fuzzy logic of the matching algorithm is configured to handle partial matches and typographical variations in the supplier mining equipment identifiers.

6. The apparatus of claim 1, wherein the data clustering of the matching algorithm groups similar supplier mining equipment identifiers based on predefined industry-specific attributes.

7. The apparatus of claim 1, wherein the operations further comprise generating one or more procurement reports on the correlated supplier mining equipment identifiers and the manufacturer mining equipment identifiers.

8. The apparatus of claim 1, wherein the matching algorithm prioritizes correlations based on historical procurement success rates between suppliers and manufacturers.

9. The apparatus of claim 1, wherein the database is configured to store metadata associated with supplier mining equipment identifiers, including mining equipment location and mining equipment specialization.

10. The apparatus of claim 1, wherein the API supports batch queries for retrieving manufacturer information for multiple supplier mining equipment identifiers simultaneously.

11. The apparatus of claim 1, wherein the operations further comprise validating supplier mining equipment identifiers against a predefined set of industry standards prior to correlation.

12. The apparatus of claim 1, wherein the matching algorithm is configured to adapt to changes in identifier formats over time.

13. The apparatus of claim 1, wherein the API is configured to integrate with one or more existing mining equipment procurement systems thereby facilitating mining equipment supplier-manufacturer interactions.

14. The apparatus of claim 1, wherein the operations further comprise providing one or more notifications to users in response to one or more new mappings between the supplier mining equipment identifiers and the manufacturer mining equipment identifiers being created in the database.

15. A computer program product comprising computer program code stored on a non-transitory computer readable storage medium and executable by a processor to perform operations comprising:
maintaining a database storing supplier mining equipment identifiers and manufacturer mining equipment identifiers;
correlating the supplier mining equipment identifiers with the manufacturer mining equipment identifiers using a matching algorithm that applies fuzzy logic and data clustering to resolve non-standardized identifier discrepancies, thereby creating mappings between the supplier mining equipment identifiers and the manufacturer mining equipment identifiers in the database; and
providing, via an application programming interface (API), dynamic, real-time access for users to query and retrieve mining equipment manufacturer information based on the correlated supplier mining equipment identifiers.

16. The computer program product of claim 15, the operations further comprising forecasting supplier-manufacturer compatibility using predictive analytics based on real-time market trends and historical procurement data, thereby optimizing supplier selection for cost efficiency and reliability.

17. The computer program product of claim 15, wherein the API is configured to support blockchain-based verification of the mining equipment and the manufacturer mining equipment identifiers thereby ensuring tamper-proof mappings for procurement transactions.

18. The computer program product of claim 15, the operations further comprising providing a dynamic pricing interface via the API, enabling users to access real-time manufacturer pricing data correlated with supplier mining equipment identifiers to facilitate competitive bidding.

19. The computer program product of claim 15, wherein the matching algorithm uses natural language processing to extract and correlate unstructured mining equipment supplier and mining equipment manufacturer data from mining industry-specific documents comprising contracts or equipment specifications and bases the mappings at least partially on the extracted and correlated unstructured mining equipment supplier and mining equipment manufacturer data.

20. An apparatus comprising:
means for maintaining a database storing supplier mining equipment identifiers and manufacturer mining equipment identifiers;
means for correlating the supplier mining equipment identifiers with the manufacturer mining equipment identifiers using a matching algorithm that applies fuzzy logic and data clustering to resolve non-standardized identifier discrepancies, thereby creating mappings between the supplier mining equipment identifiers and the manufacturer mining equipment identifiers in the database; and
means for providing, via an application programming interface (API), dynamic, real-time access for users to query and retrieve mining equipment manufacturer information based on the correlated supplier mining equipment identifiers.
